(19) United States
(12) Patent Application Publication
(10) Pub. No.: US 2023/0394322 A1
(43) Pub. Date: Dec. 7, 2023

(54) SERVER APPARATUS

(71) Applicant: NEC Corporation, Tokyo (JP)

(72) Inventor: Junki Mori, Tokyo (JP)

(73) Assignee: NEC Corporation, Tokyo (JP)

(21) Appl. No.: 18/204,031

(22) Filed: May 31, 2023

(30) Foreign Application Priority Data
Jun. 7, 2022 (JP) 2022-092302

(51) Int. Cl. G06N 3/098

(52) U.S. Cl. CPC G06N 3/098

(57) ABSTRACT

A server apparatus has: a receiving unit that receives, from a plurality of client apparatuses that perform federated learning of a neural network model having multiplex branches capable of performing different operations on a common input and learn a local model parameter of each of the multiplex branches and a weight for each branch used in superposing outputs from the respective multiplex branches, the local model parameters corresponding to each of the branches; a similarity degree calculating unit that calculates a degree of similarity between the local model parameters corresponding to each of the branches, received from different client apparatuses; a parameter calculating unit that calculates a parameter of a global model based on the local model parameter selected based on a result of calculation by the similarity degree calculating unit; and a parameter transmitting unit that transmits the parameter calculated by the parameter calculating unit to the client apparatus.

### INCORPORATION BY REFERENCE

This application is based upon and claims the benefit of priority from Japanese patent application No. 2022-092302, Jun. 7, 2022, the disclosure of which is incorporated herein in its entirety by reference.

### TECHNICAL FIELD

The present invention relates to a server apparatus, a calculation method, and a recording medium.

### BACKGROUND ART

From the viewpoint of privacy protection and the like, a technique called federated learning is known in which a plurality of clients cooperate to perform machine learning without directly exchanging training data.

A literature describing federated learning is, for example, Patent Literature 1. Patent Literature 1 describes a machine learning system that includes a plurality of client terminals and an integrated server. According to Patent Literature 1, the client terminal executes machine learning of a training target local model by using data existing in the system to which the client terminal belongs as training data in accordance with an instruction of received distribution information. The client terminal then transmits the result of learning of the local model to the integrated server. The integrated server transmits distribution information to the respective client terminals, receives the learning results from the respective client terminals, and integrates the received learning results to update a master model.

Although an averaged model is obtained in general federated learning, a technique called personalized federated learning is also known as a federated learning approach of obtaining not an averaged model but a model optimized for each client.

A literature describing personalized federated learning is, for example, Non-Patent Literature 1. For example, Non-Patent Literature 1 describes a method in which a client updates a local model of the client by receiving local models from other clients, gives a large weight to a local model that fits data of the client, and adding to the local model of the client.

Patent Literature 1: WO2021/193815

Non-Patent Literature 1: Zhang, Michael, et al. “Personalized Federated Learning with First Order Model Optimization.”, ICLR2021

In the technique described by Non-Patent Literature 1, a client needs to obtain local models of other clients, and the local models are shared among all the clients. Therefore, the risk of information leakage is high. Thus, there is a problem that it is difficult to obtain a model appropriate for each client while reducing the risk of information leakage.

### SUMMARY OF THE INVENTION

Accordingly, an object of the present invention is to provide a server apparatus, a calculation method and a recording medium that solve the abovementioned problem.

In order to achieve the object, a server apparatus as an aspect of the present disclosure includes: at least one memory configured to store instructions; and at least one processor configured to execute the instructions. The processor is configured to: receive, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches; calculate a degree of similarity between the local model parameters corresponding to each of the branches, received from different client apparatuses; calculate a parameter of a global model based on the local model parameter selected based on a result of calculation by the similarity degree calculating unit; and transmit the parameter calculated by the parameter calculating unit to the client apparatus.

Further, a calculation method as another aspect of the present disclosure is a calculation method by an information processing apparatus, and includes: receiving, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches; calculating a degree of similarity between the local model parameters corresponding to each of the branches, received from different client apparatuses; calculating a parameter of a global model based on the local model parameter selected based on a result of the calculating; and transmitting the calculated parameter to the client apparatus.

Further, a recording medium as another aspect of the present disclosure is a non-transitory computer-readable recording medium having a program recorded thereon, and the program includes instructions for causing an information processing apparatus to realize process to: receive, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches; calculate a degree of similarity between the local model parameters corresponding to each of the branches, received from different client apparatuses; calculate a parameter of a global model based on the local model parameter selected based on a result of the calculation; and transmit the calculated parameter to the client apparatus.

With the respective configurations as described above, the abovementioned problem can be solved.

### BRIEF DESCRIPTION OF DRAWINGS

FIG. 1 is a view showing an example of a general neural network;

FIG. 2 is a view showing an example of a configuration when a linear transformation of a neural network is multiplexed;

FIG. 3 is a view showing an example of a configuration of a learning system according to the first example embodiment of the present disclosure;

FIG. 4 is a block diagram showing an example of a configuration of a client apparatus;

FIG. 5 is a block diagram showing an example of a configuration of a server apparatus;

FIG. 6 is a view for describing an example of processing by a similarity degree calculating unit;

FIG. 7 is a view for describing an example of processing by a permutating unit;

FIG. 8 is a view for describing an example of processing by the permutating unit;

FIG. 9 is a flowchart showing an example of operation of the client apparatus;

FIG. 10 is a flowchart showing an example of operation of the server apparatus;

FIG. 11 is a hardware diagram showing an example of a configuration of a server apparatus in a second example embodiment of the present disclosure; and

FIG. 12 is a block diagram showing an example of a configuration of a server apparatus.

### EXAMPLE EMBODIMENT

### First Example Embodiment

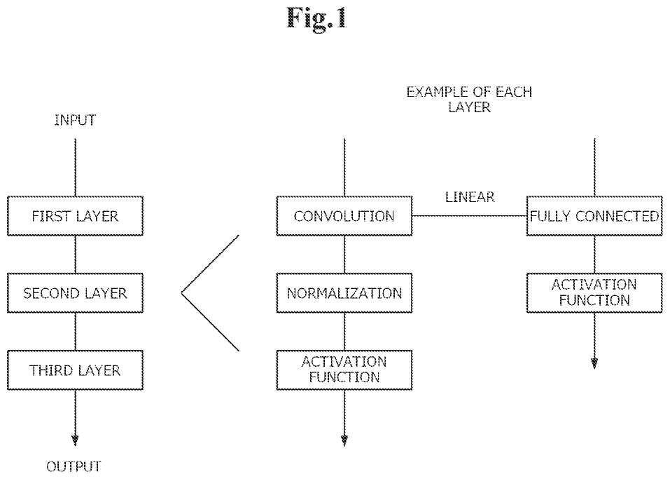

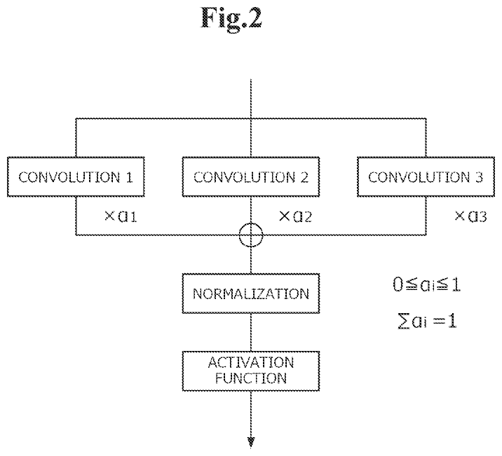

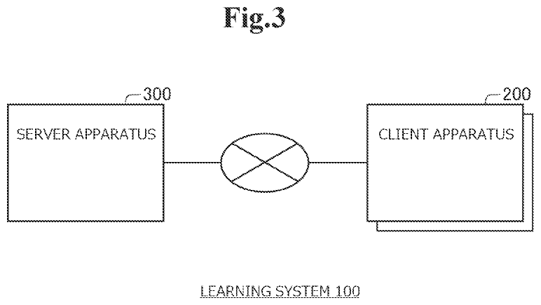

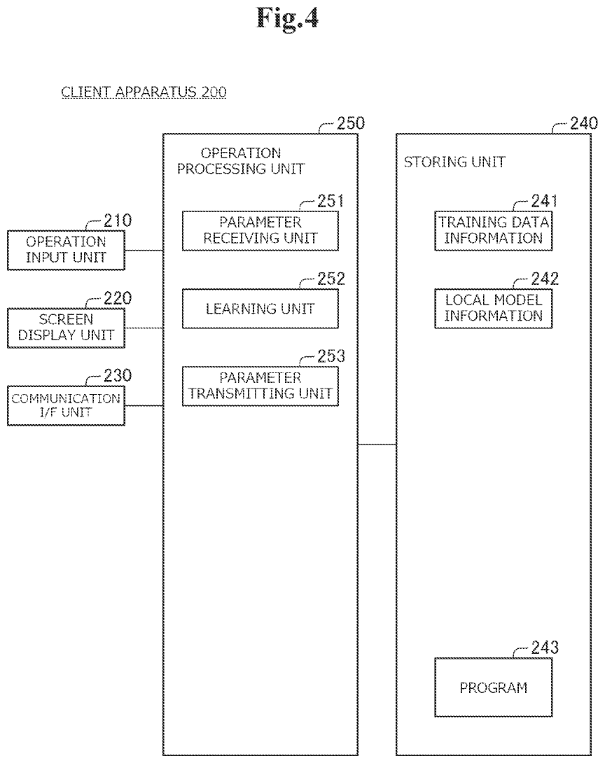

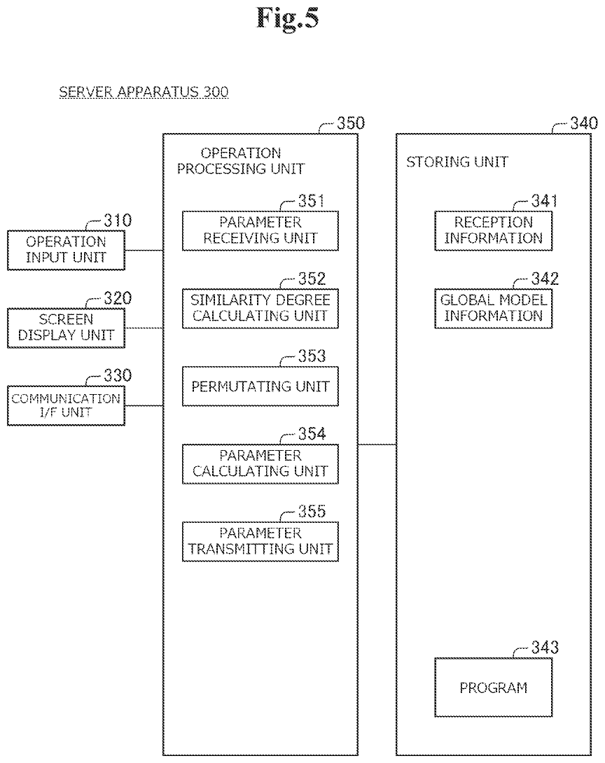

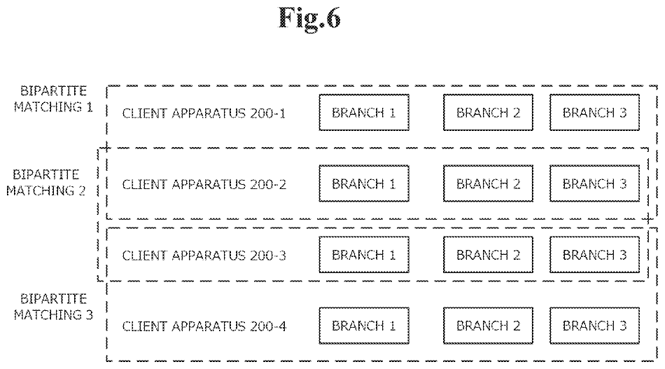

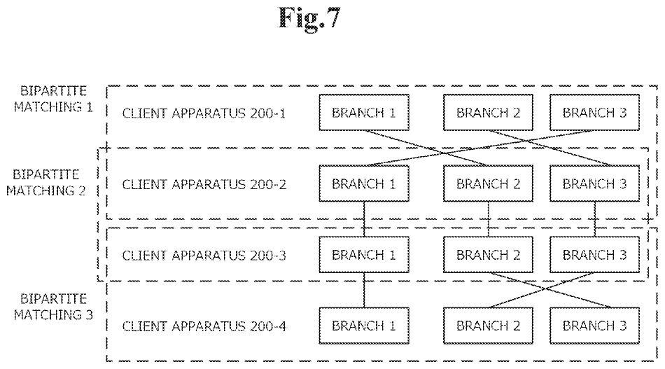

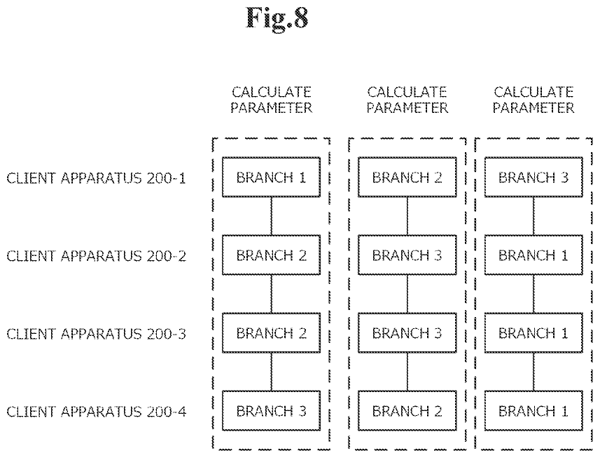

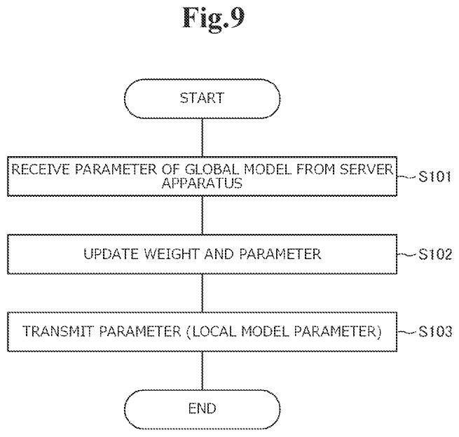

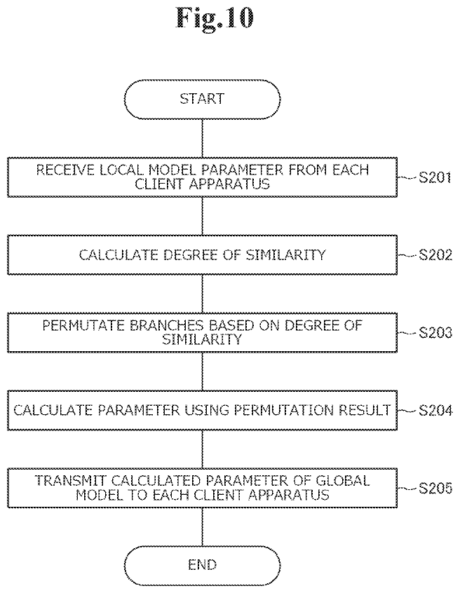

A first example embodiment of the present disclosure will be described with reference to FIGS. 1 to 10. FIG. 1 is a view showing an example of a general neural network. FIG. 2 is a view showing an example of a configuration when a linear transformation of a neural network is multiplexed. FIG. 3 is a view showing an example of a configuration of a learning system 100. FIG. 4 is a block diagram showing an example of a configuration of a client apparatus 200. FIG. 5 is a block diagram showing an example of a configuration of a server apparatus 300. FIG. 6 is a view for describing an example of processing by a similarity degree calculating unit 352. FIGS. 7 and 8 are views for describing an example of processing by a permutating unit 353. FIG. 9 is a flowchart showing an example of operation of the client apparatus 200. FIG. 10 is a flowchart showing an example of operation of the server apparatus 300.

In the first example embodiment of the present disclosure, a learning system 100 that performs federated learning in which a plurality of client apparatuses 200 and a server apparatus 300 learn in cooperation will be described. As illustrated in FIG. 1, a machine learning model learned by the learning system 100 in this example embodiment is a neural network including a plurality of layers composed of a linear transformation and a nonlinear transformation. A neural network includes a layer that includes a convolutional layer performing a convolution operation, a normalization layer performing a normalization process such as scale conversion and an activation layer using an activation function such as ReLU (Rectified Linear Unit), a layer that includes a fully connected layer and an activation layer, and the like. For example, in the case illustrated in FIG. 1, linear transformation is performed in the convolutional layer, the fully connected layer and the like, and nonlinear transformation is performed in the activation layer and the like. A neural network may have a structure such that all the layers include convolutional layers, normalization layers and activation layers, or may have a plurality of structures such as both a layer including a convolutional layer and an normalization layer and a layer including a fully connected layer and an activation layer. Moreover, the structure of a neural network is not limited to the case illustrated in FIG. 1, and may have a fourth layer or higher, for example.

Further, in the case of this example embodiment, in the machine learning model learned by the learning system 100, a linear transformation can be multiplexed. For example, as illustrated in FIG. 2, the neural network described in this example embodiment has multiplex branches that can perform different operations on a common input. For example, FIG. 2 illustrates a case where a certain layer configuring the neural network has three branches and each of the branches performs a convolutional operation. In other words, in the case illustrated by FIG. 2, a certain layer of the neural network has a branch to perform a convolution operation 1, a branch to perform a convolution operation 2 and a branch to perform a convolution operation 3, and the respective branches receive a common input. The number of branches included by one layer may be a number other than illustrated above, such as two or four or more. Each branch may perform linear transformation other than a convolutional operation, such as a fully connected operation. In the multiplex branches that receive a common input, all the branches may perform the same operation, such as a convolutional operation, or the respective branches may perform different operations, for example, some of the branches may perform a fully connected operation. Some of the branches may perform any operation other than linear transformation.

Further, in the case of this example embodiment, in the machine learning model learned by the learning system 100, outputs from the respective multiplex branches are superposed using weights for the respective branches. For example, in the machine learning model, by calculating a weighted sum that is adding the results of multiplying the outputs from the branches by weights corresponding to the branches, the outputs from the respective branches are superposed using the weights for the respective branches. For example, in the case illustrated in FIG. 2, the result of multiplying the output from a branch to perform a convolution operation 1 by weight α1 corresponding to the branch, the result of multiplying the output from a branch to perform a convolution operation 2 by weight α2 corresponding to the branch, and the result of multiplying the output from a branch to perform a convolution operation 3 by weight α3 corresponding to the branch are added. The weight is a value equal to or more than 0 and equal to or less than 1, for example. The weights corresponding to the respective branches in the same layer have a relation to be 1 when added together.

The respective branches perform a common operation using parameters common in each client apparatus 200. In other words, the parameters of the respective branches are learned by federated learning by the client apparatuses 200 and the server apparatus 300. On the other hand, a weight for each branch used in superposing the outputs from the respective multiplex branches, a normalization parameter used in a normalization layer, and the like, are learned by each client apparatus 200. Therefore, the weight, the normalization parameter, and the like, may vary for each client apparatus 200. By learning the weight and the like for each client apparatus 200, each client apparatus 200 can learn a local model appropriate for its own data.

FIG. 3 shows an example of a configuration of the learning system 100. Referring to FIG. 3, for example, the learning system 100 has the plurality of client apparatuses 200 and the server apparatus 300. As shown in FIG. 3, the client apparatuses 200 and the server apparatus 300 are connected so as to be able to communicate with each other via a network, for example. The learning system 100 may have any number of client apparatuses 200, which is equal to or more than 2.

The client apparatus 200 is an information processing apparatus that updates a parameter and the like received from the server apparatus 300 by using training data of the client apparatus 200. FIG. 4 shows an example of a configuration of the client apparatus 200. Referring to FIG. 4, the client apparatus 200 has, as major components, an operation input unit 210, a screen display unit 220, a communication I/F (interface) unit 230, a storing unit 240, and an operation processing unit 250, for example.

FIG. 4 illustrates a case of realizing a function as the client apparatus 200 by using one information processing apparatus. However, the client apparatus 200 may be realized by using a plurality of information processing apparatuses, for example, realized on the cloud. Moreover, the client apparatus 200 may not include part of the above configuration, for example, without the operation input unit 210 and the screen display unit 220, or may have a configuration other than the configuration illustrated above.

The operation input unit 210 is formed of an operation input device such as a keyboard and a mouse. The operation input unit 210 detects an operation by an operator who operates the client apparatus 200 and outputs to the operation processing unit 250.

The screen display unit 220 is formed of a screen display device such as an LCD (Liquid Crystal Display). The screen display unit 220 can display on a screen a variety of information stored in the storing unit 240 in accordance with an instruction from the operation processing unit 250.

The communication I/F unit 230 is formed of a data communication circuit and the like. The communication I/F unit 230 performs data communication with an external apparatus such as the server apparatus 300 connected via a communication line.

The storing unit 240 is a storage device such as a HDD (hard disk drive), a SSD (Solid State Drive), and memory. The storing unit 240 stores therein processing information necessary for a variety of processing by the operation processing unit 250 and a program 243. The program 243 is loaded and executed by the operation processing unit 250 to realize various processing units. The program 243 is loaded in advance from an external device and a recording medium via a data input/output function such as the communication I/F unit 230 and is stored in the storing unit 240. Major information stored in the storing unit 240 includes training data information 241, local model information 242, and the like.

The training data information 241 includes training data used when a learning unit 252 to be described later performs learning. For example, the training data information 241 is acquired in advance by a method such as acquiring from an external device via the communication I/F unit 230 or inputting with the operation input unit 210 and the like, and is stored in the storing unit 240. For example, the training data included by the training data information 241 may vary for each client apparatus 200. In this example embodiment, a specific content of the training data is not particularly limited. The training data information 241 may include any training data.

The local model information 242 includes information indicating various parameters and values configuring a local model, such as a parameter used in an operation corresponding to each branch (for example, a local model parameter), a weight for each branch used in superposing the outputs from the respective branches, and a normalization parameter. For example, the local model information 242 is updated in accordance with various processes such as reception of the parameters of the respective branches from the server apparatus 300 and learning with the training data information 241 by the learning unit 252 to be described later. The operation processing unit 250 has an arithmetic logic unit such as a CPU (Central

Processing Unit) and a peripheral circuit thereof. By loading the program 243 from the storing unit 240 and executing the program 243, the operation processing unit 250 makes the abovementioned hardware and the program 243 cooperate and realizes various processing units. Major processing units realized by the operation processing unit 250 include a parameter receiving unit 251, a learning unit 252, a parameter transmitting unit 253, and the like.

The operation processing unit 250 may have, instead of the abovementioned CPU, a GPU (Graphic Processing Unit), a DSP (Digital Signal Processor), a MPU (Micro Processing Unit), a FPU (Floating point number Processing Unit), a PPU (Physics Processing Unit), a TPU (Tensor Processing Unit), a quantum processor, a microcontroller, or a combination thereof.

The parameter receiving unit 251 receives a parameter corresponding to each of the branches in each of the layers configuring the training target neural network, from the server apparatus 300. For example, the parameter receiving unit 251 receives weight values used in performing an operation such as a convolution operation as parameters. Moreover, the parameter receiving unit 251 stores the received parameters as the local model information 242 into the storing unit 240.

The learning unit 252 performs machine learning using the training data included by the training data information 241 on a model having the parameter received by the parameter receiving unit 251, and thereby updates a parameter of each branch, a weight for each branch, and the like. In other words, the learning unit 252 performs machine learning using the training data included by the training data information 241 and updates the parameter, the weight and the like for each branch, and thereby generates a local model having a new local model parameter. Other than the parameters for the respective branches, the weights for the respective branches, and the like, the learning unit 252 may learn a normalization parameter, and the like. For example, the learning unit 252 may perform the abovementioned machine learning using a known method such as stochastic gradient descent.

For example, the learning unit 252 performs the machine learning using the training data, and thereby updates the parameter received by the parameter receiving unit 251 and calculates a new local model parameter. That is to say, a target parameter for update by the learning unit 252 is a value received by the parameter receiving unit 251, and is common in each client apparatus 200. On the other hand, the learning unit 252 performs the machine learning using the training data, and thereby updates the weight calculated in previous local model parameter calculation and calculates a new weight. That is to say, a target weight for update by the learning unit 252 is a value calculated before by each client apparatus 200, and can vary for each client apparatus 200.

The parameter transmitting unit 253 transmits a local model parameter, which is the parameter updated by the learning unit 252, to the server apparatus 300. In other words, the parameter transmitting unit 253 in this example embodiment does not transmit the weight corresponding to each of the branches, whereas transmits the local model parameter to the server apparatus 300.

The above is an example of the configuration of the client apparatus 200. Meanwhile, the configuration of the client apparatus 200 is not limited to the case illustrated above. For example, the operation processing unit 250 of the client apparatus 200 may execute the program 243 and thereby realize a converting unit that converts a plurality of branches to one branch by using the parameters of the respective branches and the weights corresponding to the respective branches. Moreover, the operation processing unit 250 of the client apparatus 200 may execute the program 243 and thereby realize an interring unit that performs inference using a local model determined in accordance with the parameter (local model parameter), the weight, and the like, indicated by the local model information 242. For example, as described above, the client apparatus 200 may have a configuration other than illustrated above.

The server apparatus 300 is an information processing apparatus that calculates the parameter of a global model by using the local model parameters received from the respective client apparatuses 200. FIG. 5 shows an example of a configuration of the server apparatus 300. Referring to FIG. 5, the server apparatus 300 has, as major components, an operation input unit 310, a screen display unit 320, a communication I/F unit 330, a storing unit 340, and an operation processing unit, for example.

FIG. 5 illustrates a case of realizing a function as the server apparatus 300 by using one information processing apparatus. However, the server apparatus 300 may be realized by using a plurality of information processing apparatuses, for example, may be realized on the cloud. Moreover, the server apparatus 300 may not include part of the configuration illustrated above, for example, may not have the operation input unit 310 and the screen display unit 320, or may have a configuration other than illustrated above.

The operation input unit 310 is formed of an operation input device such as a keyboard and a mouse. The operation input unit 310 detects an operation by an operator who operates the server apparatus 300, and outputs the operation to the operation processing unit 350.

The screen display unit 320 is formed of a screen display device such as an LCD. The screen display unit 320 can display on a screen a variety of information stored in the storing unit 340 in accordance with an instruction from the operation processing unit 350.

The communication I/F unit 330 is formed of a data communication circuit, and the like. The communication I/F unit 330 performs data communication with an external apparatus such as the client apparatus 200 connected via a communication line.

The storing unit 340 is a storage device such as a HDD, a SSD, and memory. The storing unit 340 stores therein processing information necessary for a variety of processing by the operation processing unit 350 and a program 343. The program 343 is loaded and executed by the operation processing unit 350 and thereby realizes various processing units. The program 343 is loaded in advance from an external device and a recording medium via a data input/output function such as the communication I/F unit 330 and is stored in the storing unit 340. Major information stored in the storing unit 340 includes, for example, reception information 341 and global model information 342.

The reception information 341 includes information indicating local model parameters received from the respective client apparatuses 200. For example, the reception information 341 is updated when a parameter receiving unit 351 receives information indicating local model parameters from the client apparatuses 200 via the communication I/F unit 330.

The global model information 342 includes information indicating a model parameter of a global model, calculated based on the reception information 341. For example, the global model information 342 is updated when a similarity degree calculating unit 352 to be described later calculates a parameter based on the reception information 341.

In the storing unit 340, information other than illustrated above may be stored. For example, information indicating the number of training data owned by each of the client apparatuses 200 included by the learning system 100 can be stored in the storing unit 340.

The operation processing unit 350 has an arithmetic logic unit such as a CPU and a peripheral circuit thereof. The operation processing unit 350 loads the program 343 from the storing unit 340 and executes the program 343, and thereby makes the abovementioned hardware and the program 343 cooperate and realizes various processing units. Major processing units realized by the operation processing unit 350 includes, for example, the parameter receiving unit 351, the similarity degree calculating unit 352, a permutating unit 353, a parameter calculating unit 354, and a parameter transmitting unit 355. As in the case of the operation processing unit 250 included by the client apparatus 200, the operation processing unit 350 may have, instead of the CPU, a GPU or the like.

The parameter receiving unit 351 receives a local model parameter of each branch of each layer from each client apparatus 200. Moreover, the parameter receiving unit 351 stores the received local model parameter as the reception information 341 into the storing unit 340.

The similarity degree calculating unit 352 calculates the degree of similarity between local model parameters corresponding to each branch, received from different client apparatuses 200. For example, the similarity degree calculating unit 352 performs a process of calculating the degree of similarity for each of the layers configuring the neural network.

For example, by repeating a process of calculating the degree of similarity between local model parameters received from two client apparatuses, the similarity degree calculating unit 352 can calculate the degree of similarity between local model parameters received from the respective client apparatuses 200. In other words, the similarity degree calculating unit 352 sequentially solves bipartite matching problems to calculate the degrees of similarity between the respective local model parameters.

FIG. 6 is a view for describing an example of processing by the similarity degree calculating unit 352 in the case of focusing on a certain layer configuring the neural network. The similarity degree calculating unit 352 can perform the processing as illustrated in FIG. 6 on each of the layers configuring the neural network.

Referring to FIG. 6, for example, the similarity degree calculating unit 352 first calculates the degree of similarity between a local model parameter received from the client apparatus 200-1 and a local model parameter received from the client apparatus 200-2. That is to say, the similarity degree calculating unit 352 calculates the degree of similarity between a local model parameter corresponding to a branch 1 of the client apparatus 200-1 and a local model parameter corresponding to a branch 1 of the client apparatus 200-2. Moreover, the similarity degree calculating unit 352 calculates the degree of similarity between the local model parameter corresponding to the branch 1 of the client apparatus 200-1 and a local model parameter corresponding to a branch 2 of the client apparatus 200-2. Moreover, the similarity degree calculating unit 352 calculates the degree of similarity between the local model parameter corresponding to the branch 1 of the client apparatus 200-1 and a local model parameter corresponding to a branch 3 of the client apparatus 200-2. Likewise, the similarity degree calculating unit 352 calculates the degrees of similarity between local model parameters corresponding to the branches 2 and 3 of the client apparatus 200-1 and local model parameters corresponding to the respective branches of the client apparatus 200-2. For example, as described above, the similarity degree calculating unit 352 first focuses on the client apparatus 200-1 and the client apparatus 200-2, and calculates the degrees of similarity between the respective local model parameters. The similarity degree calculating unit 352 may determine the client apparatus 200 to be focused on by any method.

Subsequently, the similarity degree calculating unit 352 calculates the degree of similarity between the local model parameter corresponding to each of the branches of the client apparatus 200-2 and the local model parameter corresponding to each of the branches of the client apparatus 200-3. After that, the similarity degree calculating unit 352 sequentially executes the same bipartite matching so that the similarity degree calculation process is performed one time or two times between one client apparatus 200 and the other client apparatus included by the learning system 100. For example, as illustrated in FIG. 6, in a case where the learning system 100 includes four client apparatuses 200, the similarity degree calculating unit 352 focuses on the client apparatus 200-2 and the client apparatus 200-3 and calculates the degrees of similarity, and thereafter focuses on the client apparatus 200-3 and the client apparatus 200-4 and calculates the degrees of similarity.

The similarity degree calculating unit 352 may calculate the degree of similarity by any method. For example, the similarity degree calculating unit 352 can calculate a norm as the degree of similarity as shown by Equation 1. For example, Equation 1 shows an example of calculation of a norm in the case of calculating the degree of similarity between vector u as a local model parameter and vector v as a local model parameter. In the case illustrated by Equation 1, the smaller the value, the higher the degree of similarity.

$$S ( u , v ) = \sqrt[p]{{\sum }_{i = 1}^{n} {\vert {u}_{i} - {v}_{i} \vert}^{p}} \qquad [ Equation 1 ]$$

where p may be any value such as 1 or 2.

Further, the similarity degree calculating unit 352 may calculate, instead of a norm, a cosine similarity as shown by Equation 2. As shown by Equation 2, the similarity degree calculating unit 352 can calculate a cosine similarity by dividing the inner product of vector u and vector v by the magnitude of vector u and vector v. In the case shown by Equation 2, the larger the value, the higher the degree of similarity.

$$S ( u , v ) = \frac{{\sum }_{i = 1}^{n} {u}_{i} {v}_{i}}{\sqrt{{\sum }_{i = 1}^{n} {u}_{i}^{2}} \sqrt{{\sum }_{i = 1}^{n} {v}_{i}^{2}}} \qquad [ Equation 2 ]$$

The similarity degree calculating unit 352 may calculate the degree of similarity between the local model parameters by a method other than the examples illustrated above. Moreover, the similarity degree calculating unit 352 may calculate the degree of similarity by a method other than bipartite matching. For example, the similarity degree calculating unit 352 may calculate the degree of similarity for all combinations of client apparatuses 200 or all combinations of branches for which the similarity degree calculation is to be performed.

The permutating unit 353 performs a permutation process of permutating the branches based on the degrees of similarity calculated by the similarity degree calculating unit 352. For example, it is assumed that the parameter calculating unit 354, which will be described later, calculates a parameter of a global model based on local model parameters corresponding to branches with the same sequential number. In this case, the permutating unit 353 permutates the branches based on the degrees of similarity so that the parameter calculating unit 354 performs the process of calculating the parameter of the global model in a combination of branches with the highest degree of similarity.

For example, it is assumed that the permutating unit 353 leaves the order of the branches unchanged in the client apparatus 200-1. That is to say, the permutating unit 353 performs identity permutation. Next, the permutating unit 353 focuses on the client apparatus 200-1 and the client apparatus 200-2, and permutates the branches corresponding to the client apparatus 200-2 so that branches with high degree of similarity have the same sequential number. After that, the permutating unit 353 focuses on the client apparatus 200-2 and the client apparatus 200-3, and permutates the branches corresponding to the client apparatus 200-3. After that, the permutating unit 353 performs the same permutation process for each combination of the client apparatuses 200 for which the similarity calculating unit 352 has calculated the degree of similarity.

For example, as illustrated in FIG. 7, in the case of focusing on the client apparatus 200-1 and the client apparatus 200-2, combinations with the highest degrees of similarity are a combination of the branch 1 of the client apparatus 200-1 and the branch 2 of the client apparatus 200-2, a combination of the branch 2 of the client apparatus 200-1 and the branch 3 of the client apparatus 200-2, and a combination of the branch 3 of the client apparatus 200-1 and the branch 1 of the client apparatus 200-2. In this case, the permutating unit 353 permutates the branches corresponding to the client apparatus 200-2 so that the branches with high degree of similarity have the same sequential number, that is, the branches corresponding to the client apparatus 200-2 are arranged in order of the branch 2, the branch 3, and the branch 1. After that, the permutating unit 353 performs a process of permutating the branches corresponding to the client apparatus 200-3 and the client apparatus 200-4 based on the degrees of similarity calculated by the similarity degree calculating unit 352.

The parameter calculating unit 354 calculates a parameter of the global model based on local model parameters selected based on the result of calculation of the degree of similarity by the similarity degree calculating unit 352. For example, the parameter calculating unit 354 selects branches with the same sequential number as a target for calculation based on the result of the permutation process by the permutating unit 353, and calculates a parameter of the global model. Moreover, the parameter calculating unit 354 stores the calculated parameter of the global model as the global model information 342 into the storing unit 340.

For example, referring to FIG. 8, as a result of the permutation process by the permutating unit 353, the branch 1 of the client apparatus 200-1, the branch 2 of the client apparatus 200-2, the branch 2 of the client apparatus 3, and the branch 3 of the client apparatus 4 have the same sequential number. Then, the parameter calculating unit 354 calculates the parameter of a branch 1 in the global model based on the local model parameter corresponding to the branch 1 of the client apparatus 200-1, the local model parameter corresponding to the branch 2 of the client apparatus 200-2, the local model parameter corresponding to the branch 2 of the client apparatus 200-3, and the local model parameter corresponding to the branch 3 of the client apparatus 200-4. Likewise, in the case illustrated in FIG. 8, the parameter calculating unit 354 calculates the parameter of a branch 2 in the global model based on the local model parameter corresponding to the branch 2 of the client apparatus 200-1, the local model parameter corresponding to the branch 3 of the client apparatus 200-2, the local model parameter corresponding to the branch 3 of the client apparatus 200-3, and the local model parameter corresponding to the branch 2 of the client apparatus 200-4. Also, the parameter calculating unit 354 calculates the parameter of a branch 3 in the global model based on the local model parameter corresponding to the branch 3 of the client apparatus 200-1, the local model parameter corresponding to the branch 1 of the client apparatus 200-2, the local model parameter corresponding to the branch 1 of the client apparatus 200-3, and the local model parameter corresponding to the branch 1 of the client apparatus 200-4.

Specifically, for example, the parameter calculating unit 354 calculates a parameter of the global model based on a plurality of local model parameters by performing weighting using the number of training data owned by the client apparatus 200 and then calculating the average of the local model parameters. For example, the parameter calculating unit 354 can calculate a parameter of the global model based on a plurality of local model parameters by solving an equation shown in Equation 3.

$${W}_{i , j} = \frac{1}{n} {\sum }_{k = 1}^{K} {n}_{k} {W}_{i , {σ}_{k}^{- 1} ( j )}^{( k )} \qquad [ Equation 3 ]$$

where n indicates the total number of data owned by each client apparatus, nₖ indicates the number of data owned by a client apparatus k, K is the total number of the client apparatuses 200 included by the learning system 100, Wᵢⱼ indicates a parameter of the j-th branch of the i-th layer, and σ⁻¹(j) indicates a branch before permutation that becomes the branch j after permutation.

The parameter calculating unit 354 may calculate a parameter of the global model by a method other than illustrated above. For example, the parameter calculating unit 354 may be configured to, without performing weighting using the number of training data, calculate the average of the respective local model parameters. Moreover, the parameter calculating unit 354 may be configured to select a combination of branches with a high degree of similarity based on the result of similarity degree calculation by the similarity degree calculating unit 352, and calculate a parameter of the global model using the selected combination.

The parameter transmitting unit 355 transmits the parameter of the global model calculated by the parameter calculating unit 354 to the client apparatus 200. The parameter transmitting unit 355 may return the branch of the global model to the branch before permutation and thereafter transmit to the client apparatus.

The above is an example of the configuration of the server apparatus 300. Subsequently, an example of operation of the learning system 100 will be described with reference to FIGS. 9 and 10. First, with reference to FIG. 9, an example of operation of the client apparatus 200 will be described.

FIG. 9 is a flowchart showing an example of operation of the client apparatus 200. Referring to FIG. 9, the parameter receiving unit 251 receives a parameter corresponding to each of the branches in each of the layers configuring a neural network to be trained from the server apparatus 300 (step S101).

The learning unit 252 performs machine learning using training data included by the training data information 241 on a model having the parameter received by the parameter receiving unit 251, and thereby updates a parameter of each of the branches, a weight for each of the branches, and the like (step S102). For example, the learning unit 252 may perform the machine learning by a known method such as stochastic gradient descent.

The parameter transmitting unit 253 transmits a local model parameter, which is the parameter updated by the learning unit 252, to the server apparatus 300 (step S103).

The above is an example of the operation of the client apparatus 200. Subsequently, with reference to FIG. 10, an example of operation of the server apparatus 300 will be described.

FIG. 10 is a flowchart showing an example of operation of the server apparatus 300. Referring to FIG. 10, the parameter receiving unit 351 receives a local model parameter of each of the branches from each of the client apparatuses 200 (step S201).

The similarity degree calculating unit 352 calculates a degree of similarity between local model parameters corresponding to each branch that are received from different client apparatuses 200 (step S202). For example, by repeatedly executing a process of calculating a degree of similarity between local model parameters received from two client apparatus, the similarity degree calculating unit 352 can calculate the degrees of similarity between the local model parameters received from the respective client apparatuses. In other words, the similarity degree calculating unit 352 sequentially solves bipartite matching to calculate the degrees of similarity between the respective local model parameters.

The permutating unit 353 performs a permutation process of permutating the branches based on the degrees of similarity calculated by the similarity degree calculating unit 352 (step S203). For example, the permutating unit 353 permutates the branches based on the degrees of similarity so that a process of calculating the parameter of the global model by the parameter calculating unit 354 is performed in a combination of branches with high degree of similarity.

The parameter calculating unit 354 calculates the parameter of the global model based on the local model parameters selected based on the result of the similarity degree calculation by the similarity degree calculating unit 352 (step S204). For example, the parameter calculating unit 354 selects branches with the same sequential number as a calculation target based on the result of the permutation process by the permutating unit 353, and calculates the parameter of the global model.

The parameter transmitting unit 355 transmits the parameter of the global model calculated by the parameter calculating unit 354 to the client apparatuses 200 (step S205). Meanwhile, the parameter transmitting unit 355 may return the branches of the global model to the branches before permutation and transmit to the client apparatus.

The above is an example of the operation of the server apparatus 300. In the learning system 100, a series of steps as illustrated with reference to FIGS. 9 and 10 are repeated, for example, until a predetermined end condition is satisfied. Any end condition may be determined, for example, the series of steps are repeated a predetermined number of times.

Thus, the server apparatus 300 has the parameter calculating unit 354 and the parameter transmitting unit 355. With such a configuration, the parameter transmitting unit 355 can transmit the parameter calculated by the parameter calculating unit 354 to the client apparatuses 200. As a result, each of the client apparatuses 200 can update the local model parameter and the weight by using the received parameter. Consequently, without sharing the local model between the client apparatuses 200, for example, each of the client apparatuses 200 can learn the weight and thereby train the local model appropriate for its own data. As a result, it is possible to reduce the risk of information leakage.

Furthermore, the server apparatus 300 described in this example embodiment has the similarity degree calculating unit 352 and the parameter calculating unit 354. With such a configuration, the parameter calculating unit 354 can calculate the parameter of the global model based on the local model parameters selected based on the result of similarity degree calculation by the similarity degree calculating unit 352. Conventionally, without calculating the degree of similarity, the average has been taken between the same branches at all times. As a result, learning may become unstable when parameters far apart have the same sequential number. In the case of the server apparatus 300 described in this example embodiment, as mentioned above, the parameter of the global model is calculated by averaging the similar parameters. As a result, more stable learning is possible as compared with the conventional case, and more accurate learning is possible.

### Second Example Embodiment

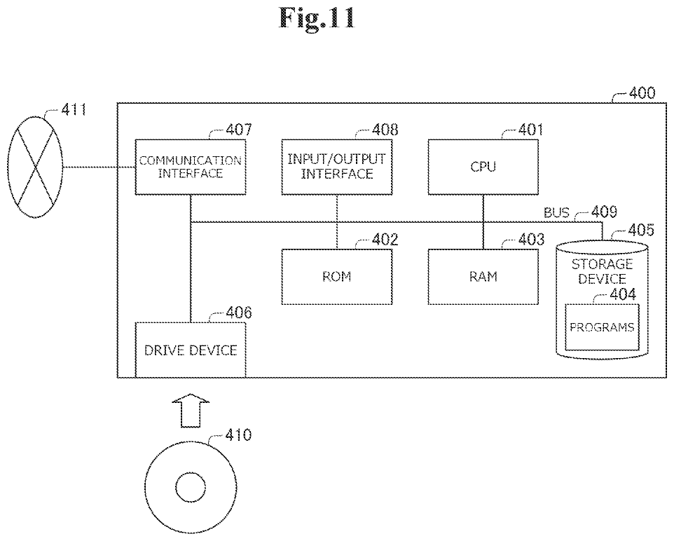

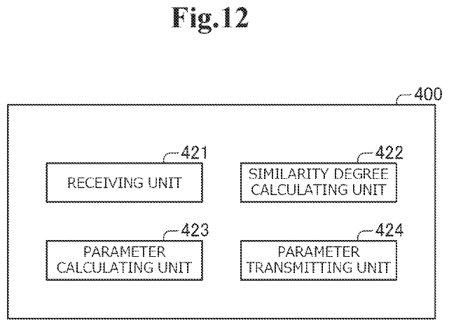

Next, a second example embodiment of the present disclosure will be described with reference to FIGS. 11 and 12. FIG. 11 is a view showing an example of a hardware configuration of a server apparatus 400. FIG. 12 is a block diagram showing an example of a configuration of the server apparatus 400.

In the second example embodiment of the present disclosure, an example of the configuration of the server apparatus 400 that is an information processing apparatus performing learning in cooperation with an external apparatus such as a client apparatus will be described.

Referring to FIG. 11, as an example, the server apparatus 400 has the following hardware configuration including;

a CPU (Central Processing Unit) 401 (arithmetic logic unit),

a ROM (Read Only Memory) 402 (memory unit),

a RAM (Random Access Memory) 403 (memory unit),

programs 404 loaded to the RAM 403,

a storage device 405 for storing the programs 404,

a drive device 406 that reads from and writes into a recording medium 410 outside the information processing apparatus,

a communication interface 407 connected to a communication network 411 outside the information processing apparatus,

an input/output interface 408 that inputs and outputs data, and

a bus 409 that connects the respective components.

The server apparatus 400 may use, instead of the abovementioned CPU, a GPU (Graphic Processing Unit), a DSP (Digital Signal Processor), a MPU (Micro Processing Unit), a FPU (Floating point number Processing Unit), a PPU (Physics Processing Unit), a TPU (Tensor Processing Unit), a quantum processor, a microcontroller, or a combination thereof.

Further, the server apparatus 400 can realize functions as a receiving unit 421, a similarity degree calculating unit 422, a parameter calculating unit 423, and a parameter transmitting unit 424 shown in FIG. 12 by acquisition and execution of the programs 404 by the CPU 401. For example, the programs 404 are stored in the storage device 405 and the ROM 402 in advance, and are loaded to the RAM 403 and executed by the CPU 401 as necessary. Moreover, the programs 404 may be supplied to the CPU 401 via the communication network 411, or may be stored in the recording medium 410 in advance and retrieved and supplied to the CPU 401 by the drive device 406.

FIG. 11 shows an example of a hardware configuration of the server apparatus 400. The hardware configuration of the server apparatus 400 is not limited to the above case. For example, the server apparatus 400 may include part of the abovementioned configuration, for example, without the drive device 406.

The receiving unit 421 receives, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches.

The similarity degree calculating unit 422 calculates the degree of similarity between the local model parameters corresponding to each of the branches, received from different client apparatuses.

The parameter calculating unit 423 calculates a parameter of a global model based on a local model parameter selected based on the result of calculation by the similarity degree calculating unit 422.

The parameter transmitting unit 424 transmits the parameter calculated by the parameter calculating unit 423 to the client apparatus.

Thus, the server apparatus 400 has the parameter calculating unit 423 and the parameter transmitting unit 424. With such a configuration, the parameter transmitting unit 424 can transmit a parameter calculated by the parameter calculating unit 423 to the client apparatus. As a result, the client apparatus can update a local model parameter and a weight using the received parameter, for example. Consequently, without sharing the local model among the client apparatuses, each client apparatus can learn a local model appropriate for its own data by learning a weight for each client apparatus, for example. As a result, the risk of information leakage can be reduced.

Furthermore, the server apparatus 400 described in this example embodiment has the similarity degree calculating unit 422 and the parameter calculating unit 423. With such as configuration, the parameter calculating unit 423 can calculate a parameter of a global model based on the local model parameter selected based on the result of similarity degree calculation by the similarity degree calculating unit 422. As a result, it is possible to make learning more stable as compared with a case where selection based on the degree of similarity is not performed, and it is possible to perform learning with higher accuracy.

The server apparatus 400 described above can be realized by installation of a predetermined program in an information processing apparatus such as the server apparatus 400. Specifically, a program as another aspect of the present invention is a computer program for causing an information processing apparatus such as the server apparatus 400 to realize processes to: receive, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches; calculate the degree of similarity between the local model parameters corresponding to each of the branches, received from different client apparatuses; and calculate a parameter of a global model based on a local model parameter selected based on the result of calculation.

Further, a calculation method executed by an information processing apparatus such as the server apparatus 400 described above is a method by an information processing apparatus such as the server apparatus 400 of: receiving, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches; calculating the degree of similarity between the local model parameters corresponding to each of the branches, received from different client apparatuses; and calculating a parameter of a global model based on a local model parameter selected based on the result of calculation.

The inventions of a program, a computer-readable recording medium having a program recorded thereon, and a calculation method with the abovementioned configurations also have the same actions and effects as the server apparatus 400 described above, and therefore, can achieve the abovementioned object of the present invention.

### <Supplementary Notes>

The whole or part of the example embodiments disclosed above can be described as the following supplementary notes. Below, the overview of a server apparatus and the like according to the present invention. However, the prevent invention is not limited to the following configurations.

### (Supplementary Note 1)

A server apparatus comprising:

a receiving unit configured to receive, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches;

a similarity degree calculating unit configured to calculate a degree of similarity between the local model parameters corresponding to each of the branches, received from different client apparatuses;

a parameter calculating unit configured to calculate a parameter of a global model based on the local model parameter selected based on a result of calculation by the similarity degree calculating unit; and

a parameter transmitting unit configured to transmit the parameter calculated by the parameter calculating unit to the client apparatus.

### (Supplementary Note 2)

The server apparatus according to Supplementary Note 1, wherein the similarity degree calculating unit is configured to, by repeatedly executing a process of calculating the degree of similarity between the local model parameters received from two client apparatuses, calculate the degrees of similarity between the local model parameters received from the plurality of client apparatuses.

### (Supplementary Note 3)

The server apparatus according to Supplementary Note 1, wherein the similarity degree calculating unit is configured to calculate the degree of similarity between the local model parameter corresponding to each of the branches received from a first client apparatus among the plurality of client apparatuses and the local model parameter corresponding to each of the branches received from a second client apparatus different from the first client apparatus, and thereafter calculate the degree of similarity between the local model parameter corresponding to each of the branches received from the second client apparatus and the local model parameter corresponding to each of the branches received from a third client apparatus different from the second client apparatus.

### (Supplementary Note 4)

The server apparatus according to Supplementary Note 1, wherein the parameter calculating unit is configured to select the branches corresponding to the respective client apparatuses so as to combine the branches with highest similarity degree based on the result of calculation by the similarity degree calculating unit.

### (Supplementary Note 5)

The server apparatus according to Supplementary Note 1, comprising a permutating unit configured to permutate the branches based on the result of calculation by the similarity degree calculating unit,

wherein the parameter calculating unit is configured to select the branches to be a parameter calculation target based on a result of permutation by the permutating unit.

### (Supplementary Note 6)

The server apparatus according to Supplementary Note 5, wherein the permutating unit is configured to permutate the branches so as to combine the branches with highest similarity degree.

### (Supplementary Note 7)

The server apparatus according to Supplementary Note 5, wherein the parameter calculating unit is configured to calculate the parameter of the global model by calculating an average value of the branches with a same sequential number after permutation by the permutating unit.

### (Supplementary Note 8)

A calculation method by an information processing apparatus, the method comprising:

receiving, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches;

calculating a degree of similarity between the local model parameters corresponding to each of the branches, received from different client apparatuses;

calculating a parameter of a global model based on the local model parameter selected based on a result of the calculating; and

transmitting the calculated parameter to the client apparatus.

### (Supplementary Note 9)

The calculation method according to Supplementary Note 8, comprising by repeatedly executing a process of calculating the degree of similarity between the local model parameters received from two client apparatuses, calculating the degrees of similarity between the local model parameters received from the plurality of client apparatuses.

### (Supplementary Note 10)

A computer program comprising instructions for causing an information processing apparatus to realize process to:

receive, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches;

calculate a degree of similarity between the local model parameters corresponding to each of the branches, received from different client apparatuses;

calculate a parameter of a global model based on the local model parameter selected based on a result of the calculation; and

transmit the calculated parameter to the client apparatus.

Although the present invention has been described above with reference to the example embodiments, the present invention is not limited to the abovementioned example embodiments.

The configurations and details of the present invention can be changed in various manners that can be understood by one skilled in the art within the scope of the present invention

### Description of Reference Numerals

100 learning system
200 client apparatus
210 operation input unit
220 screen display unit
230 communication I/F unit
240 storing unit
241 training data information
242 local model information
243 program
250 operation processing unit
251 parameter receiving unit
252 learning unit
253 parameter transmitting unit
300 server apparatus
310 operation input unit
320 screen display unit
330 communication I/F unit
340 storing unit
341 reception information
342 global model information
343 program
350 operation processing unit
351 parameter receiving unit
352 similarity degree calculating unit
353 permutating unit
354 parameter calculating unit
355 parameter transmitting unit
400 server apparatus
401 CPU
402 ROM
403 RAM
404 programs
405 storage device
406 drive device
407 communication interface
408 input/output interface
409 bus
410 recording medium
411 communication network
421 receiving unit
422 similarity degree calculating unit
423 parameter calculating unit
424 parameter transmitting unit

1. A server apparatus comprising:
at least one memory configured to store instructions; and
at least one processor configured to execute the instructions to:
receive, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches;
calculate a degree of similarity between the local model parameters corresponding to each of the branches, received from different client apparatuses;
calculate a parameter of a global model based on the local model parameter selected based on a result of calculation by the similarity degree calculating unit; and
transmit the parameter calculated by the parameter calculating unit to the client apparatus.

2. The server apparatus according to claim 1, wherein the processor is configured to execute the instructions to
by repeatedly executing a process of calculating the degree of similarity between the local model parameters received from two client apparatuses, calculate the degrees of similarity between the local model parameters received from the plurality of client apparatuses.

3. The server apparatus according to claim 1, wherein the processor is configured to execute the instructions to
calculate the degree of similarity between the local model parameter corresponding to each of the branches received from a first client apparatus among the plurality of client apparatuses and the local model parameter corresponding to each of the branches received from a second client apparatus different from the first client apparatus, and thereafter calculate the degree of similarity between the local model parameter corresponding to each of the branches received from the second client apparatus and the local model parameter corresponding to each of the branches received from a third client apparatus different from the second client apparatus.

4. The server apparatus according to claim 1, wherein the processor is configured to execute the instructions to
select the branches corresponding to the respective client apparatuses so as to combine the branches with highest similarity degree based on the result of calculation by the similarity degree calculating unit.

5. The server apparatus according to claim 1, wherein the processor is configured to execute the instructions to
permutate the branches based on the result of calculation by the similarity degree calculating unit; and
select the branches to be a parameter calculation target based on a result of permutation by the permutating unit.

6. The server apparatus according to claim 5, wherein the processor is configured to execute the instructions to
permutate the branches so as to combine the branches with highest similarity degree.

7. The server apparatus according to claim 5, wherein the processor is configured to execute the instructions to
calculate the parameter of the global model by calculating an average value of the branches with a same sequential number after permutation by the permutating unit.

8. A calculation method by an information processing apparatus, the method comprising:
receiving, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches;
calculating a degree of similarity between the local model parameters corresponding to each of the branches, received from different client apparatuses;
calculating a parameter of a global model based on the local model parameter selected based on a result of the calculating; and
transmitting the calculated parameter to the client apparatus.

9. The calculation method according to claim 8, comprising
by repeatedly executing a process of calculating the degree of similarity between the local model parameters received from two client apparatuses, calculating the degrees of similarity between the local model parameters received from the plurality of client apparatuses.

10. A non-transitory computer-readable recording medium having a program recorded thereon, the program comprising instructions for causing an information processing apparatus to realize process to:
receive, from a plurality of client apparatuses that perform federated learning of a neural network model having multiplex branches capable of performing different operations on a common input and thereby learn a local model parameter of each of the multiplex branches and a weight for each branch used in superposing outputs from the respective multiplex branches, the local model parameters corresponding to each of the branches;
calculate a degree of similarity between the local model parameters corresponding to each of the branches, received from different client apparatuses;
calculate a parameter of a global model based on the local model parameter selected based on a result of the calculation; and
transmit the calculated parameter to the client apparatus.
